(19) United States
(12) Patent Application Publication
(10) Pub. No.: US 2008/0160357 A1
(43) Pub. Date: Jul. 3, 2008

(54) Increased Conductivity and Enhanced Electrolytic and Electrochemical Processes

(75) Inventors: Richard Mark Pashley, Australian Capital Territory (AU); Lawrence Richard Pashley, Australian Capital Territory (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: THE AUSTRALIAN NATIONAL UNIVERSITY, Acton (AU)

(21) Appl. No.: 11/794,207

(22) PCT Filed: Dec. 23, 2005
(86) PCT No.: PCT/AU2005/001953

§ 371 Date: Nov. 9, 2007

(30) Foreign Application Priority Data
Dec. 23, 2004 (AU) 2004907268

(51) Int. Cl. H01M 8/04; B01D 17/06; C02F 1/461

(52) U.S. Cl. 429/14; 205/742; 205/688

(57) ABSTRACT

The invention relates generally to processes for improving or increasing the electrical conductivity of aqueous liquids by way of removal of dissolved gases therein. Use of degassed aqueous liquids in water based electrolysis processes such as electrodialysis, may advantageously improve the efficiency of such a process.

### FIELD OF THE INVENTION

The present invention relates generally to processes for improving or increasing the electrical conductivity of aqueous liquids by way of removal of dissolved gases therein (degassing). Use of degassed aqueous liquids in processes which rely on the conductivity of the liquid, such as electrodialysis, may advantageously improve the efficiency of such processes. The invention therefore also relates to the use of degassed aqueous liquids in electrolytic and electrochemical processes, as well as methods for concentrating, separating or removing dissolved ions in aqueous liquids.

### BACKGROUND OF THE INVENTION

The reference to any prior art in this specification is not, and should not be taken as, an acknowledgment or any form of suggestion that that prior art forms part of the common general knowledge in Australia.

The contents of all references cited in this document are taken to be incorporated herein, in their entirety, for all purposes.

Fresh water is needed in all aspects of human life, not only essential for drinking supplies but for use in sanitation, agricultural and industrial applications.

Of the total global stock of water, only a small fraction of this is fresh water. Approximately 70% of this global fresh water stock is locked in polar ice caps and a significant proportion of the remaining lies in remote underground aquifers. In effect, less than 1% of the earth's total fresh water is available for direct human use. Population growth only places further pressures on this already limited resource.

Given the abundance of readily accessible ocean/sea water, improved processes for desalination are the subject of considerable effort and research. Indeed, the United Nations declared this “the century of ocean water desalination” (Pilat, B., Desalination 139, 389-92, 2001).

Although large-scale plants for seawater desalination are dominated by evaporative and reverse osmosis processes, substantial improvements in electrodialysis (ED), particularly with regard to the materials used for the ionic exchange membranes, have occurred over the last decade or so and have returned this process to favour. Electrodialysis (Mulder, M., Basic Principles of Membrane Technology, Kluwer, London, 1991) utilises the movement of charged entities when an electric potential gradient is applied. Ions are transported through ion selective permeable (anion and cation exchange) membranes under the influence of a potential gradient generated by applying a voltage between two end electrodes. Cations move towards the anode through the cation exchange membrane and anions move toward the cathode, passing the anion exchange membrane. Conductivity (the reciprocal of resistivity) is defined as the ratio of the current density to the electric field strength and thus is a measure of how well a material accommodates the transport of electric charge. In “pure” water, conductance is based on the transport of protons and hydroxyl ions, largely by water molecule linkages and sequential bond cleavage (Eisenberg, D. and Kauzmann, W., The Structure and Properties of Water, Oxford, UK, 1969).

Given the advantages such as: high recovery ratio, less requirement for precise pre-treatment, energy usage proportional to salt concentration rather than volume (for sea water, about 1 kWh for 1 kg salt), long membrane life expectancy and resistance of membranes to antibacterial attack, ED is a viable large-scale alternative process to evaporative and reverse osmosis methods.

Carbon dioxide gas, which dissociates in water to form HCO₃⁻ and CO₃²⁻, places an additional anionic load on the ED process. Thus, dissolved CO₂ is typically removed from the water prior to electrodialysis. This is industrially achieved by use of membrane contactors. Membrane contactors (such as hollow fibre filters) are hydrophobic membranes that allow a gas and a liquid to contact each other without mixing by virtue of the pressure difference created when water comes in contact with the hydrophobic pores of the membrane. For CO₂ removal from water, the water flows on one side of the membrane while a sweep gas (eg. N₂ or air) flows on the other side.

Henry's law dictates that the dissolved CO₂ is drawn from the water, travels across the membrane into the sweep gas phase, thereby removing the CO₂. By reducing the ionic load (HCO₃⁻ and CO₃²⁻), power consumption and operating costs of ED are reduced.

By virtue of the added ionic load consequences of dissolved CO₂, degassing prior to ED has up until now been restricted to consideration of CO₂ removal only. Dissolved non-polar gases such as N₂, do not dissociate and contribute to the ionic load and therefore were considered to be inert. In the classic work of Kohlrausch and Heydweiller (Kohlrausch, F. and Heydweiller, A., Z. phys. Chem. 14, 317, 1894), the conductivity of pure water, 0.058 μScm⁻¹ at 25° C., was measured for clean, vacuum distilled water, which was distilled under only partial vacuum to facilitate distillation, and not to remove dissolved oxygen and nitrogen. The commonly accepted literature value is 0.055 μScm⁻¹ at 25° C.(Aylward G. and Findlay, T., SI Chemical Data, 3^{rd} Edn, J.Wiley, NY, 1994) and therefore presumably also measured without removal of dissolved oxygen and nitrogen.

It has now surprisingly been found however, that the removal of non-polar gases such as N₂ and O₂ can significantly increase the conductivity of water, thereby affording a new opportunity to further improve the efficiency of processes, such as ED, which depend on the electrical properties (conductivity) of water.

### SUMMARY OF THE INVENTION

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Removal of substantially all dissolved gases from water has been found to increase the electrical conductivity of water and may therefore enhance the rate or efficiency of electrolytic or electrochemical cells.

Accordingly, in a first aspect, the invention provides a method for enhancing the electrical conductivity of an aqueous liquid, such as water, comprising the step of degassing the liquid.

In a second aspect, the invention provides a method of conducting or passing a current through an aqueous liquid comprising the steps of
(i) degassing the aqueous liquid
(ii) applying an electric field to the aqueous liquid.

An increase in electrical conductivity of water decreases its resistivity. Therefore this may advantageously reduce the power requirements for processes which depend on, or are affected by, the inherent conductivity of the water in aqueous ionic solutions, such as in the electrodialysis process. From elementary calculations (Lee, H.-J., et al, Desalination, 142, 267-286, 2002), it can be seen that any decrease in the current density, or increased current through a cell for a given voltage, would result in an overall decrease in the energy consumption per unit product. In general, the enhanced conductivity achieved by degassing may improve the efficiency of water-based electrolysis processes and even batteries or electrochemical cells such as the car lead-acid batteries. Thus, by first degassing an aqueous liquid which is to be subjected to an electrolytic process, such as electrodialysis, or an electrochemical process, the efficiency of the process may advantageously be improved. The invention therefore also relates to the use of a degassed aqueous liquid in a process which utilizes the conductivity of the liquid.

In a third aspect, the invention relates to the use of a degassed aqueous liquid in an electrolysis or electrochemical process, particularly an electrodialysis process.

Thus, in a fourth aspect, the invention provides a method for concentrating, separating or removing ions from an aqueous liquid comprising:
(i) degassing said aqueous liquid; and
(ii) subjecting the degassed liquid to electrodialysis.

The invention also provides a method for pretreating an aqueous liquid for use in an electrolysis or electrochemical process comprising the step of degassing the aqueous liquid. The aqueous liquid may be any ionic solution, for example electrolytes, buffers, solutions of inorganic salts, solutions of organic salts, and acids and bases.

A preferred embodiment provides method for pretreating an aqueous liquid for use in an electrodialysis process comprising the step of degassing said liquid. In a particularly preferred embodiment, the aqueous liquid is water containing from about 10% to about 0.1% dissolved NaCl.

Preferably the aqueous liquid is substantially degassed (particularly of N₂, O₂ and CO₂) and most preferably at least 99% of the dissolved gases are removed.

In a particularly preferred embodiment of the invention, the aqueous liquid is sea water or brackish water.

### BRIEF DESCRIPTION OF THE FIGURES

FIG. 1 is a schematic representation of the electrodialysis process.

FIG. 2 schematically illustrates ion depletion next to membrane surfaces.

FIG. 3 graphically depicts the effect of nitrogen purging on the electrical conductivity of water.

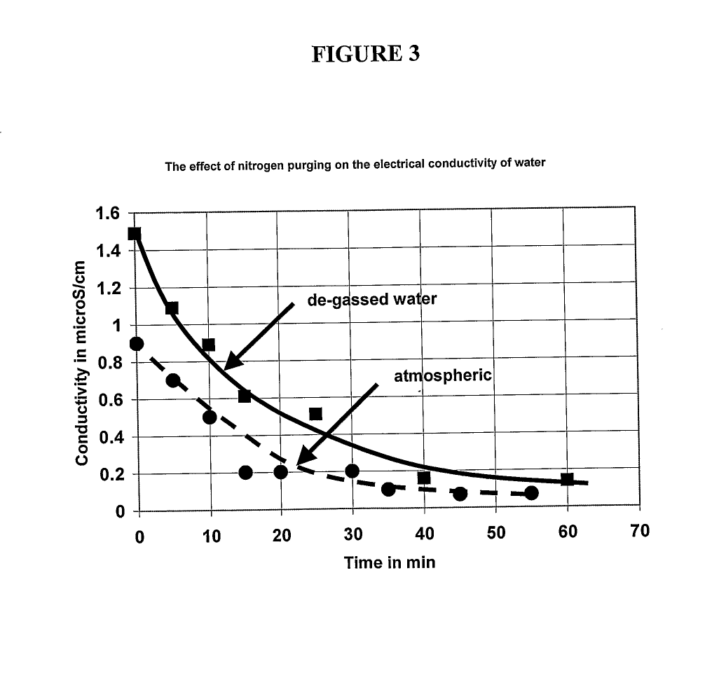

FIG. 4 graphically depicts calculated mid-plane ion concentrations with time for a 2 mm spacing between planar anion and cation exchange membranes.

### DETAILED DESCRIPTION OF THE INVENTION

The singular forms “a”, “an” and “the” include the plural aspects unless the context indicates otherwise.

As used herein, the term “degassing” or variations such as “degassed” or “degas” refers to the removal of at least a proportion of the total amount of gas or gases, particularly CO₂, N₂ and O₂, dissolved in an aqueous liquid. For example, at equilibrium with air at 25° C. and at 1 atm, water contains approximately 8.5 ppm O₂, 14.5 ppm N₂, and trace amounts of CO₂ (˜10 μM). Preferably the aqueous liquid is substantially degassed, for example at least 80% of dissolved gas is removed from the aqueous liquid, more preferably at least 90% or 95%. Most preferably at least 97% or 99% of dissolved gases are removed and even more preferably about 99.9-99.99% are removed. A liquid substantially free of dissolved gases is one where at least 80% have been removed, and more preferably, at least 99%.

The amount of any gas remaining in the degassed liquid can be measured by the usual techniques known in the art. If the gases are non-selectively removed, measurement of one gas provides an adequate indication of the extent of degassing achieved. For example, the presence of any remaining dissolved oxygen can be detected by dissolved oxygen electrode systems. In a preferred form, the degassed liquid contains only about 10-100 ppb O₂, more preferably about 1-10 ppb.

The phrase “aqueous liquid” includes water and aqueous solutions of dissolved ionic salts, (which dissociate in water to form ions). Non-limiting examples include sulfates, carbonates, bicarbonates, phosphates and halides (chloride, bromide, iodide and fluoride) of hydrogen, lithium, sodium, magnesium, potassium, calcium, zinc, silver, nickel, copper, iron and manganese as appropriate. It will be appreciated that aqueous liquids may also contain non-ionic species such as sugars, proteins, amino acids and enzymes from which it may be desirable to remove, separate or concentrate dissolved ionic species.

Since NaCl is a major component of seawater, the concentration, separation or removal of Na⁺ and Cl⁻ ions from water is one embodiment which is especially contemplated. Particular examples of aqueous liquids considered herein include sea or ocean water and brackish water. The terms “seawater” and “ocean water” are used herein interchangeably.

Seawater is water from the sea or ocean. Brackish water is water found between fresh and marine climates, such as where lakes or rivers flow into the ocean. Although brackish water contains less dissolved salts than sea water, it is nevertheless unsuitable for drinking, or many agricultural and industrial applications. Seawater and brackish water generally contain a number of dissolved salts in the form of ions which include chlorine, sodium, sulfate, magnesium, calcium and potassium ions. NaCl is the major dissolved salt. Although the salinity of water varies greatly depending on its source, the salinity of sea and brackish water can range from 3.5-3% down to about 1% down to about 0.1% NaCl (wt %). It will be appreciated that the methods of the invention are equally applicable to other aqueous liquids obtained from other sources, eg well water, underground springs or laboratory or industrial waste waters, eg. electroplating waste or (hot dip) galvanising liquors. In addition, although the above values are typical for sea water and brackish water, aqueous liquids with dissolved ionic salt ranges which fall out side the above-mentioned ranges, be they seawater, brackish water or from other sources, also fall within the scope of the invention. Less than 1000 ppm NaCl is considered to be “fresh water ” and 500 ppm is considered to be the upper limit for “drinking water”. Thus degassed water containing at least 500 (0.05%)-1000 ppm (0.1%) dissolved NaCl is contemplated for use in electrodialysis according to the present invention.

Degassing can be carried out using any methods known in the art. One such method, typically used in the laboratory, is the freeze-pump-thaw method whereby the liquid phase is frozen in liquid nitrogen and out-gassed by applying a vacuum. Following removal of the gas, the frozen liquid is allowed to thaw and the remaining gases are drawn into the space above the liquid to be removed by vacuum again once the liquid has been refrozen. The cycle may be repeated several times.

On a larger scale, vacuum towers can also be used to degas the aqueous liquid. In such towers, a system of increasing vacuum is applied as water droplets fall through various pumping and out-gassing phases.

In more recent years, microporous membranes have increasingly been used to degas aqueous liquid phases. The technology has now moved from small laboratory scale devices to large-scale industrial devices suitable for water treatment systems operating at hundreds to thousands of litres per minute. Microporous membranes allow a gaseous phase and a liquid phase to come into contact with one another for the purpose of mass (gas) transfer without dispersing one phase into another. Typically these can be used to remove gases dissolved in water. These processes utilise the phenomenon of surface tension and the resulting pressure difference which occurs across a curved liquid interface when a liquid makes contact with a surface. Successful and efficient membrane-mediated degassing of a liquid requires a very high surface area of contact per unit volume of fluid. This can be achieved with hollow fibre filter or membrane units (also known as contactors). Typically, these comprise the membrane in the form of hollow fibre bundles housed in a case or shell. Commercial membrane contactors, including hollow fibre filters and hollow-fibre-contained-liquid-membrane contactors, are readily available. It will be recognised that in order to obtain maximum degassing it may be necessary to perform the degassing process more than once. A single contactor may be used and the progressively degassed hydrophobic liquid can be passed or cycled through. Alternatively a plurality of membrane contactors may be connected in series, for example, 2, 3 or 4 units. A number of contactors may be connected in parallel.

In electrodialysis, pairs of membranes, one being selectively permeable to cations and the other selectively permeable to anions, are placed between a pair of electrodes. These membranes are arranged alternately with an anion-selective membrane followed by a cation-selective membrane.

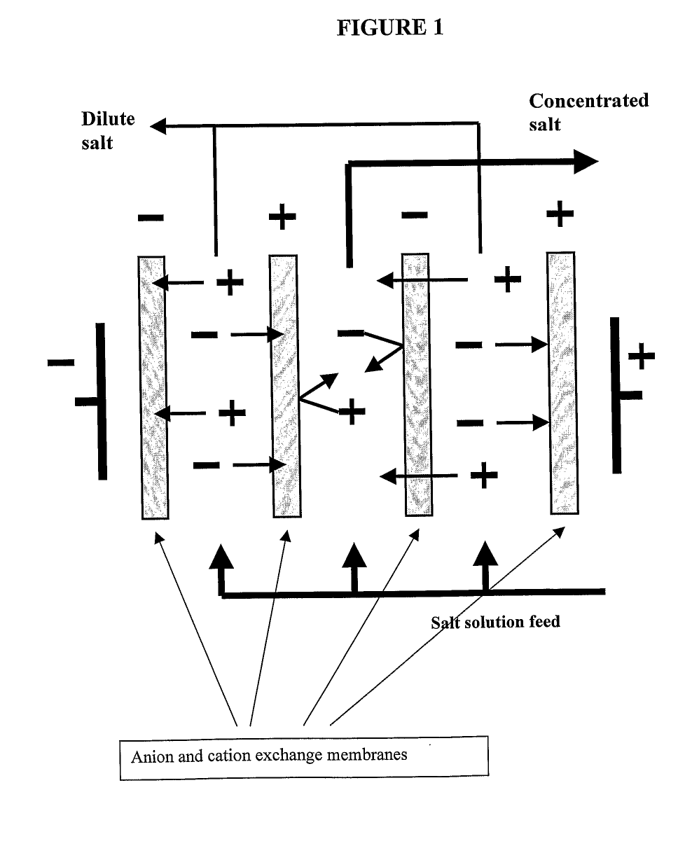

On application of an electric field, the anions in the water are attracted and diverted towards the positive electrode. The anions pass through the anion-selective membrane, but cannot pass any farther than the cation-selective membrane, which blocks its path and traps the anion. Similarly, cations under the influence of the negative electrode move in the opposite direction through the cation-selective membrane to the channel on the other side. Here, the cations are trapped because the next membrane is anion-selective and prevents further movement towards the electrode. This process is schematically depicted in FIG. 1.

By this arrangement, concentrated and diluted solutions are created in the spaces between the alternating membranes. These spaces, bounded by two membranes (one anionic and the other cationic) are called cells. The cell pair consists of two cells, one from which the ions migrated (the dilute cell for the product water) and the other in which the ions concentrate (the concentrate cell for the brine stream).

The basic electrodialysis unit may consist of 10 or more, up to several hundred, cell pairs bound together with electrodes on the outside and is referred to as a membrane stack. Feed water passes simultaneously in parallel paths through all of the cells to provide a continuous flow of desalted water and brine to emerge from the stack.

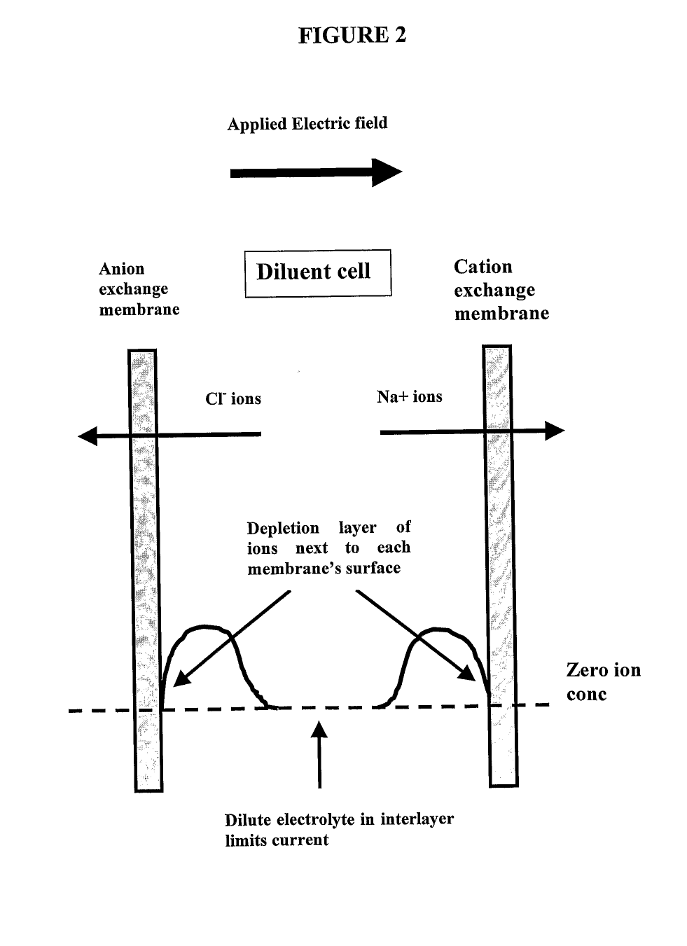

The rate at which the process can proceed is directly related to the overall electrical conductivity of the series of membranes and intermediate solutions. Any region which has very low salt levels will limit the overall rate at which the ions can be transported and so limit the rate of desalination. The dilution of the electrolyte will occur in the regions between the charged membranes and in the ion depletion layers next to each ion exchange membrane and these will substantially increase the electrical resistance in the system. This is illustrated in FIG. 2. However, by degassing the feed solution, the electrical conductivity of the dilute electrolyte created in the diluent cell and next to each membrane is inherently increased. Thus the invention also has application to water-based electrolysis processes in general wherein ion depletion layers may form, such as batteries or electrochemical cells.

Thus the methods of the invention may be used to prepare desalinated water, suitable for drinking, eg less than 500 ppm NaCl, sanitation, agricultural or industrial purposes from ED of salt (NaCl)-containing aqueous liquids such as seawater and brackish water. Membrane separators are currently used commercially to degas water (Tai, M. S. L., Chua, I., Li, K., Ng, W. J. and Teo, W. K. Journal of Membrane Science, 1994, 87(1-2), 99-105; Wiesler, F., Ultrapure Water, March 2003, 38-42), producing drinking water via vacuum distillation from salt water feed. The resulting degassed concentrated salt solution by-product of this process could be used directly as the feed solution to a second stage ED process. NaCl concentrations contemplated herein range from about 10%NaCl, down to about 3.5%, down to about 1% down to about 0.1 or 0.05%. As a by-product, ED also produces a concentrated brine suitable for the preparation of table salt.

It will be appreciated that the use of degassed liquids in electrodialytic processes is not just limited to desalination of salt (NaCl)-containing water but may be used, as appropriate, in any electrodialysis process which treats aqueous solutions containing dissolved ions for the purpose of their concentration, separation or removal. Electrodialysis has many applications and is used for the purification, concentration or recovery of organic acids (eg. lactic, acetic) and inorganic acids (eg. H₂SO₄), demineralisation of dairy products, eg. whey processing, demineralisation and purification of enzymes and proteins, desalination and purification of sugar solutions, demineralisation and purification of amino acid solutions, production of low salt soy sauce, purification of fruit juices, blood purification (such as in kidney haemodialysis wherein enhanced conductivity of a degassed water could reduce the dialysis time), removing potassium tartrate from wine, removing Ag (I) salts from photographic wastes, removing Ni (II) from electroplating waters, removing Zn (II) from galvanizing waters, recovering acids and water from metal pickling baths and hot dip galvanizing wastes, purifying water for boiler feeds and cooling towers, rinse waters for electronics processing, removal of nitrates, boron elimination, nitric acid concentration, glycerin recovery and removing or recovering ionic solutes from food products, or chemical or industrial waste liquors (such as environmental waste water cleaning, eg. purification of effluent streams), in general. Thus an aqueous liquid may also contain one or more of inorganic or organic acids, proteins, enzymes, amino acids, metals or sugars.

Degassed aqueous liquids may also enhance the reaction rates of electrolytic processes such as chlorine production. Chlorine is produced electrolytically using diaphram and membrane cells (63%) and mercury cells (37%). These processes rely on the conductivity of the brine solution. These membrane cells described utilise an ion exchange membrane to prevent the anolyte and catholyte streams form mixing. As well as the production of chlorine, hydrogen is produced and can be independently captured. The brine solution serves the double purpose of increasing the conductivity and acts as a source of chlorine. As the conductivity of the electrolyte is a major factor governing electrolysis reaction rates, degassing it will yield greater volumes of hydrogen. Degassed liquids may also be useful in SPE (Solid Polymer Electrolyte) Fuel Cells which may benefit from higher conductivity electrolytes.

The invention will now be described with reference to the following examples which are provided for the purpose of illustrating certain embodiments of the invention and are not to be construed as limiting the generality hereinbefore described.

### EXAMPLES

### Materials and Methods

In the experimental studies reported here, distilled water was produced from tap water via a sequential process of coarse filtration, activated charcoal filtration, reverse osmosis filtration and, finally, distillation into a Pyrex glass storage vessel housed in a laminar flow, clean air cabinet.

Samples of clean, distilled water were out-gassed by a process of repeated freezing in liquid nitrogen, followed by pumping down to a pressure of typically about 0.01 mbar, or less, and then melting in a sealed Pyrex tube. The dissolved gas liberated on each melting cycle was removed on re-freezing. Although this process was carried out five times, typically no further degassing on melting was observed after 3-4 cycles. The vacuum pressure of 0.01 mbar corresponds to a de-gassing level of about 99.999%. This latter value is calculated on the assumption that the final pressure achieved on several cycles of freeze/thaw/pumping is given by the pressure in equilibrium with the final frozen liquid, which on being melted does not give any visible bubbling or out-gassing. This level of degassing can be attained commercially via membrane separators (Tai, M. S. L., Chua, I., Li, K., Ng, W. J. and Teo, W. K. Journal of Membrane Science, 1994, 87(1-2), 99-105; Wiesler, F., Ultrapure Water, March 2003, 38-42). The degassed water was used within minutes after degassing. All water transfers were carried out in laminar flow, filtered air cabinets. In addition, conductivity measurements on degassed water were carried out immediately after disconnection from the vacuum line and in an environment of nitrogen gas, to prevent carbon dioxide dissolution. Electrical conductivity measurements were also carried out on ordinary distilled water equilibrated with the atmosphere, in distilled water following bubbling with clean nitrogen gas and in fully degassed water. All measurements were performed in Pyrex vessels. The change in conductivity with time was also measured for de-gassed water and distilled water equilibrated with the atmosphere, when exposed to gentle bubbling of high purity nitrogen gas. The temperature of the water was measured and its pH monitored. For distilled water, pH values were measured after the addition of a small amount of pure NaCl to stabilise the measuring current of the glass electrode.

The electrical conductivity of degassed, distilled water samples were measured by rapid transference of the water from the freeze-thaw vacuum system to the conductivity measuring probe. In addition, measurements were also made in situ using a Pt electrode system housed in a vacuum tube, in connection with a second tube. Using this system the electrical conductivity could be measured with no exposure to the atmosphere. The water was degassed, using the freeze-thaw method in the second tube. The Pt cell was then completely evacuated and the de-gassed water transferred to the Pt cell, under vacuum. This technique was used because the Pt cell could not be safely exposed to liquid nitrogen temperatures and freezing water.

Four different types of conductivity meter and cells were used in this study: a Radiometer CDM 80 conductivity meter was used with a three electrode cell (platinum black coated) at a frequency of 50 Hz; a Lovibond Con 200 conductivity meter (using a graphite electrode); a manual Philips PR 9500 conductivity meter were also used (at 50 Hz) and a Radiometer CDM210 with CDC866T probe.

### Example 1

Results Obtained on Single Distilled Water

The results obtained for the electrical conductivity of water under a range of conditions is summarised in Table 1. These results are compared with standard literature values, with the appropriate conditions under which they were measured. All values are in μScm⁻¹. The temperatures and pH values are given in brackets.

TABLE 1
Values for the electrical conductivity of water under various conditions.

| Conditions. | Results. | Literature values. |
|---|---|---|
| Equilibrated with air | 0.9 (pH 5.7) | 0.7^{lit.} |
| Nitrogen gassed | 0.07 (22° C., pH 7.0) | |
| De-gassed | 1.2 (22° C., pH 7.0) | |
| Standard value - unknown | 0.055 (25° C.) | |
| conditions*: | | |

*Kohlrausch and Heydweiller (1894) and SI Data book.
^{lit.}Robinson, R. A., and Stokes, R. H.

These results clearly demonstrate that degassing has a substantial effect on increasing the electrical conductivity of water. Literature values from the SI data book are: 0.042 μScm⁻¹ at 20° C. (24 Mohm-cm) and 0.055 μScm⁻¹ at 25° C. (18 Mohm-cm). These values are consistent with those measured in the classic work of Kohlrausch and Heydweiller who measured a value of 0.058 μScm⁻¹ at 25° C. These values are typically obtained for commercial ultrapure water units such as those produced by Millipore. However, these values appear to correspond to the conductivity of water with CO₂ removed but not non-polar dissolved gases, such as oxygen and nitrogen. Much higher values are obtained for atmospheric, carbon dioxide equilibrated pure water—about 0.75 μScm⁻¹ (Robinson, R. A. and Stokes, R. H. Electrolyte Solutions. 2^{nd} edn. 1959 Butterworths, London).

However, the results of over 30 different experiments on the de-gassing of distilled water, using both the transfer in air method and the measurements in situ, indicates that complete de-gassing causes an increase in conductivity to about 1.2 (+/−0.2) μScm⁻¹. The pH of the de-gassed water was found to be 7.0 (+/−0.2), as expected. By comparison, it was found that nitrogen bubbling through either single distilled water (atmosphere equilibrated) or completely de-gassed distilled water reduces its conductivity to around 0.07 μScm⁻¹ at pH 7.0. Thus, nitrogen purging can reduce the conductivity of even single distilled water to values close to those accepted in the literature for ultrapure water. Complete de-gassing actually increases the electrical conductivity above the value for atmosphere equilibrated water, which contains dissolved CO₂.

It is interesting that the theoretical conductivity of pure water is often calculated from the equilibrium 10⁻⁷ M concentration (actually at about 24° C.) and the conductivities at infinite dilution of H₃O+ and OH⁻ ions. The ion conductivities of the corresponding electrolyte solutions (NaCl, NaOH and HCl) would, presumably, have been measured under CO₂ free nitrogen (i.e. rather than in completely de-gassed solutions) for convenience. Extrapolation to infinite dilution for the hydroxyl ion and hydronium ion in water of Λ_{OH} (infinite dilution)=199.2 Scm²mol⁻¹ and Λ_{H} (infinite dilution)=350.1 Scm² mol⁻¹. Hence: Λ(total)=(199.2+350.1)×10⁻¹⁰ Scm⁻¹=0.055 μScm⁻¹ at 25° C. This value is the same as that accepted as ‘standard’, see for example the SI data Book and agrees closely with the best measured value of Kohlrausch and Heydweiller of 0.058 μScm⁻¹. This standard calculation, once again, appears to correspond to CO₂ free but not de-gassed water. The standard values for water conductivity with temperature also agree closely with the values obtained by Kohlrausch.

The results presented here, indicate that the precise value for ‘pure’ water depends on the presence or absence of dissolved, non-polar gases. Previously, only the effects of dissolved carbon dioxide have been considered.

It is interesting that the major water purification company Millipore (Millipore—Technical Publications—Ultrapure Water for Elemental Analysis down to ppt levels. July 2004 Site: www.millipore.com/publications.nsf/docs/rd002) recently stated that: ‘It is clear that 18.2 Mohm·cm is no longer a “quality certification” value.’ This was because latest developments in ICP-MS ultratrace analysis were pushing back the definition of ‘pure water’. The water used in this example was prepared as standard laboratory ‘single-distilled’ water and stored in Pyrex vessels in a laminar flow cabinet. It is surprising that the values obtained here, simply by thoroughly purging with high purity nitrogen gas, should give water with conductivity values reasonably close to the best values published in the literature.

### Example 2

The Effect of Salt Water Degassing on Electrodialysis

The forces acting on ions in water under the influence of a static electric field can be well described by the electromobility values for each specific ion in water. For example, the mobility, U₊₋, of an ion can be expressed as the ratio of drift speed S₊₋ (in the direction of the applied field) to the strength of the applied field E:

$$∴ {U}_{+ -} = \frac{{S}_{+ -}}{E}$$

Because of Brownian motion, S₊₋ must be the average ‘drift’ in the direction of the field for all the ions of this type present in solution. Typical measured values are given in the following table:

| | Ion: | | | | |
|---|---|---|---|---|---|
| | Li⁺ | Na⁺ | K⁺ | Ca²⁺ | Cl⁻ |
| U/cm² sec⁻¹ V⁻¹ | 4.01 × 10⁻⁴ | 5.19 × 10⁻⁴ | 7.62 × 10⁻⁴ | 6.17 × 10⁻⁴ | 7.91 × 10⁻⁴ |

Which means, for example, that under an applied field of, say, 1 V/cm these ions would move at a mean speed of about 6×10⁻⁴ cm/sec, which is much lower than the instantaneous (random) speeds due to Brownian collisions, O(10⁴ cm/sec). The mobility of ions is related to the total current flow in an electric field and hence the solution conductivity. The amount of charge passing through a plane of area A per unit time in an electrolyte solution, perpendicular to the applied field E, is called the flux J and is given by:

J=nqₑE(U₊v₊z₊+U₋v₋|z₋|)

where n is the number of molecules of electrolyte of formula: Mᵥ_{₊}^{z}_{₊}Xᵥ_{_{−}}^{z}_{_{−}} per unit volume of solution and qₑ positive value of the electronic charge. Both positively and negatively charged ions contribute to the overall flux. J will have (S.I.) units of C sec⁻¹ m², that is, charge per sec across unit cross-sectional area. From the definition of current, I=JA, where A is the cross-sectional area through which the current flows:

I=nqₑEA(U₊v₊z₊+U₋v₋|z₋|)

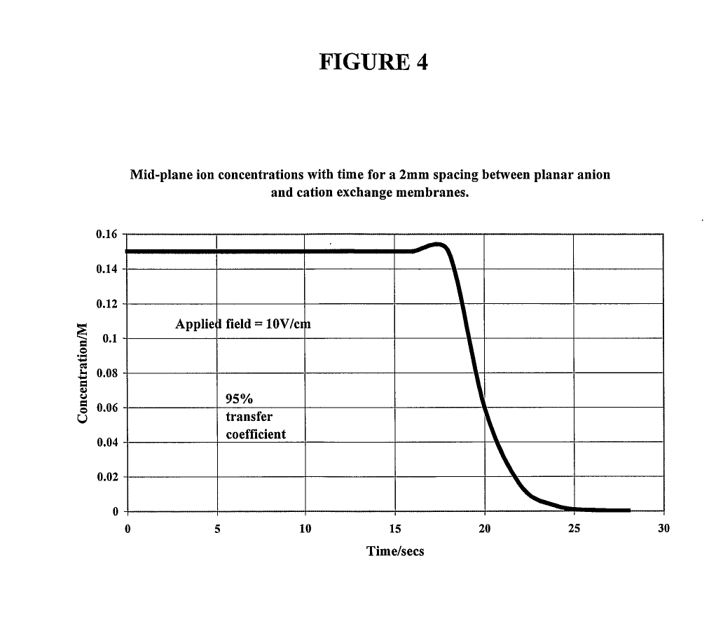

Using the applied electric field and the cell dimensions in an electrodialysis unit cell, it is therefore possible to calculate the rate of depletion of NaCl with time at the mid-plane between two ion exchange membranes in the diluent cell (see FIGS. 1&2) starting from an initial concentration of 0.15M (salt water). The mid-plane was chosen in this analysis so that the second term in the Nernst-Planck electrolyte transport equation (Mulder, M., Basic Principles of Membrane Technology, Kluwer, London, 1991) for ion diffusion under the action of a concentration gradient, used to fully describe the ion flux in this case, can be ignored. Thus, only the electrical forces need be considered. If at time zero a 0.15M NaCl solution occupies a 2 mm space between an anion and cation exchange membrane, then the concentration at the mid-plane can be calculated as function of time, following the application of a an applied electric field of 10V/cm using the appropriate ion mobilities in the table given above. Typical results are summarised in FIG. 4. In this calculation it was assumed that there was a 95% efficiency of transfer of ions under the action of the electric field, due to the effects of random thermal motion.

These calculations, although approximate, clearly show that even after a short period of time, the applied electric field creates a reduction in concentration at the mid-plane which will create a large increase in electrical resistance, reducing the overall ion flux in the cell. These results can be applied to the overall ED unit. If the diluent cell, after this length of time, creates a 0.2 mm layer of depleted salt (<0.01 mM) and the rest of the cell (1.8 mm) contains an average salt concentration of, say, 0.01M, the electrical resistance (per unit cross sectional area) of the depleted region is 365 kohm/cm² and of the residual salt region 150 Ohm/cm². If it is assumed that the concentrate cell has a NaCl concentration of 0.3M, it contributes a resistance of 7 ohm/cm². These calculations clearly demonstrate that the depleted salt regions dominate the overall resistance of the ED unit. Thus, for a combined 10-cell unit, of 5 concentrates and 5 diluent cells, the overall resistance would be 1.8 Mohm/cm². However, if the salt solution feed was degassed, the increased electrical conductivity of the depleted regions of the diluent cells would reduce this overall resistance to 84 kohm/cm². Put simply, the overall resistance is dominated by the high resistance of the salt depleted regions and these are the most dramatically affected by de-gassing. The depletion layer thickness assumed in this model is conservative and even larger depleted regions will form in practice, during the electrodialysis process.

In this calculation the effect of dissolved CO₂ gas has been ignored because of its low level, of about 10 μM, which means that the dissociated proton and bicarbonate ions will be rapidly removed from the system, along with the much higher level of Na⁺ and Cl⁻ ions, to the two ion exchange membranes. Also, any gas diffusion back into the narrow space between the membranes will be much slower than the ion flux.

In addition to the ion depletion at the mid-plane of the diluent cell, there will also be ion depletion layers next to each ion exchange membrane because of the rapid transport of these ions through these membranes. This depletion will set up a concentration driven ion diffusion process. This effect has also been ignored as a contribution to the flux because the 10% (ie 0.2 mm) depletion layer in the diluent cell can reasonably be assumed to include both these two depletion layers, as well as the mid-plane layer.

### BIBLIOGRAPHY

Aylward G. and Findlay, T., SI Chemical Data, 3^{rd} edn, J.Wiley, NY, 1994.
Eisenberg, D. and Kauzmann, W., The Structure and Properties of Water, Oxford, UK, 1969.
Kohlrausch, F. and Heydweiller, A., Z. phys. Chem. 14, 317, 1894.
Lee, H.-J., et al, Desalination, 142, 267-286, 2002.
Millipore—Technical Publications—Ultrapure Water for Elemental Analysis down to ppt levels. July 2004.
   Site: www.millipore.com/publications.nsf/docs/rd002
Mulder, M., Basic Principles of Membrane Technology, Kluwer, London, 1991.
Pilat, B., Desalination 139, 389-92, 2001.
Robinson, R. A. and Stokes, R. H. Electrolyte Solutions. 2^{nd} edn. 1959 Butterworths, London.
Tai, M. S. L., Chua, I., Li, K., Ng, W. J. and Teo, W. K. Journal of Membrane Science, 1994, 87(1-2), 99-105.
Wiesler, F., Ultrapure Water, March 2003, 38-42.

1. A method of conducting a current through an aqueous liquid comprising the steps of
(i) degassing the aqueous liquid
(ii) applying an electric field to the aqueous liquid.

2. A method according to claim 1 wherein the liquid is in an electrolysis or electrochemical cell.

3. A method according to claim 2 wherein the liquid is in an electrodialysis cell.

4. A method for concentrating, separating or removing ions from an aqueous liquid comprising:
(i) degassing said aqueous liquid; and
(ii) subjecting the degassed liquid to electrodialysis.

5. The method of claim 1, wherein the aqueous liquid is degassed of at least 80% of dissolved N₂, O₂ and C0₂.

6. A method according to claim 5 wherein the aqueous liquid is degassed of at least 99% of dissolved N₂, O₂ and C0₂.

7. The method of claim 4, wherein the aqueous liquid is water containing dissolved NaCl from about 10% to about 0.05%.

8. The method of claim 4, wherein the degassed aqueous liquid is a concentrated salt solution by-product from vacuum distillation.

9. The method of claim 4, wherein the aqueous liquid contains one or more of organic or inorganic acids enzymes, proteins, sugars, amino acids, metals or nitrates.

10-11. (canceled)

12. A method for pretreating an aqueous liquid for use in an electrolysis or electrochemical process comprising the step of degassing the aqueous liquid.

13. A method for pretreating an aqueous liquid for use in an electrodialysis process comprising the step of degassing said liquid.

14. A method according to claim 13 wherein the aqueous liquid is water containing from about 10 to about 0.1% dissolved NaCl or contains one or more of organic or inorganic acids enzymes, proteins, sugars, amino acids, metals or nitrates.

15. The method of claim 3 for the purpose of one of: the purification, concentration or recovery of organic acids and inorganic acids, demineralisation of dairy products, demineralisation and purification of enzymes and proteins, desalination and purification of sugar solutions, demineralisation and purification of amino acid solutions, production of low salt soy sauce, purification of fruit juices, blood purification, removing potassium tartrate from wine, removing Ag (1) salts from photographic wastes, removing Ni (II) from electroplating waters, removing Zn (II) nom galvanizing waters, recovering acids and water from metal pickling baths and hot dip galvanizing wastes, purifying water for boiler feeds and cooling towers, rinse waters for electronics processing, removal of nitrates, boron elimination, nitric acid concentration, glycerin recovery and removing or recovering ionic solutes from food products, or chemical or industrial waste liquors.

16. The method of claim 1 for the production of chlorine.

17. A method according to claim 2 wherein the cell is an SPE Fuel Cell.

18. The method of claim 2, wherein the aqueous liquid is degassed of at least 80% of dissolved N₂, O₂ and C0₂.

19. The method of claim 3, wherein the aqueous liquid is degassed of at least 80% of dissolved N₂, O₂ and C0₂.

20. The method of claim 4, wherein the aqueous liquid is degassed of at least 80% of dissolved N₂, O₂ and C0₂.

21. The method of claim 4 for the purpose of one of: the purification, concentration or recovery of organic acids and inorganic acids, demineralisation of dairy products, demineralisation and purification of enzymes and proteins, desalination and purification of sugar solutions, demineralisation and purification of amino acid solutions, production of low salt soy sauce, purification of fruit juices, blood purification, removing potassium tartrate from wine, removing Ag (1) salts from photographic wastes, removing Ni (II) from electroplating waters, removing Zn (II) nom galvanizing waters, recovering acids and water from metal pickling baths and hot dip galvanizing wastes, purifying water for boiler feeds and cooling towers, rinse waters for electronics processing, removal of nitrates, boron elimination, nitric acid concentration, glycerin recovery and removing or recovering ionic solutes from food products, or chemical or industrial waste liquors.
